(19) United States
(12) Patent Application Publication
(10) Pub. No.: US 2013/0127427 A1
(43) Pub. Date: May 23, 2013

(54) REGULATOR, ELECTRONIC DEVICE INCLUDING THE REGULATOR

(71) Applicants: Jiazhou Liu, Shanghai (CN); Dawei Guo, Shanghai (CN); Yanfeng Wang, Shanghai (CN)

(72) Inventors: Jiazhou Liu, Shanghai (CN); Dawei Guo, Shanghai (CN); Yanfeng Wang, Shanghai (CN)

(21) Appl. No.: 13/316,559

(22) Filed: Dec. 12, 2011

(30) Foreign Application Priority Data
Nov. 21, 2011 (CN) 201110369595.4

(51) Int. Cl. G05F 1/10

(52) U.S. Cl. 323/268

(57) ABSTRACT

A regulator includes an output circuit receives a feedback voltage and provides an output current based on the feedback voltage, an output voltage of the regulator is based on the output current; a first MOSFET coupled to the output circuit and receives the output voltage of the regulator; a second MOSFET coupled to the first MOSFET provides the feedback voltage based on, at least in part, the output voltage; a current sink coupled to the first MOSFET and the second MOSFET and receive jointly a current from the first MOSFET and a current from the second MOSFET; a current source coupled to the second MOSFET and provides the second MOSFET with the current, a connection of the current source and the second MOSFET is further coupled to the output circuit and provides the feedback voltage based on, at least in part, the current in the second MOSFET.

### CLAIM OF PRIORITY

This application claims priority to Chinese Application No. 201110369595.4 filed on Nov. 21, 2011, which is incorporated herein by reference.

### TECHNICAL FIELD

The present application relates to regulators, and more particularly but not limited to energy-efficient regulators and electronic devices including the same.

### BACKGROUND

An integrated circuit (IC) may include a great number of components with different operating voltages. However, one chip usually has only one power supply providing a fixed voltage, e.g., about 3V, about 5V, etc. Therefore, regulators are necessary to transform the fixed voltage to the operating voltages.

A conventional regulator includes an operational amplifier and two resistors. Any voltage which is lower than the power supply voltage and higher than a reference voltage can be provided by the regulator. However, a power consumption of the amplifier is exorbitant in case the regulator is supported by a battery and the power efficiency requirement is very high.

Therefore, a new regulator is required.

### SUMMARY OF THE INVENTION

In some embodiments of the invention, a regulator without an operational amplifier is provided for power efficiency. Specifically, the regulator comprises an output circuit and a feedback loop, the feedback loop monitors any change of an output voltage provided by the output circuit and provides a control voltage for the output circuit according to the changed output voltage. The change of the output voltage is thereby offset.

In an embodiment of the invention, a regulator comprises an output circuit configured to receive a feedback voltage and provide an output current based on the feedback voltage, wherein an output voltage of the regulator is based on, at least in part, the output current; a first MOSFET coupled to the output circuit and configured to receive the output voltage of the regulator; a second MOSFET coupled to the first MOSFET and configured to provide the feedback voltage based on, at least in part, the output voltage; a current sink coupled to the first MOSFET and the second MOSFET and configured to receive jointly a current from the first MOSFET and a current from the second MOSFET; a current source coupled to the second MOSFET and configured to provide the second MOSFET with the current in the second MOSFET, a connection of the current source and the second MOSFET is further coupled to the output circuit and configured to provide the feedback voltage based on, at least in part, the current in the second MOSFET.

In an embodiment, an electronic device comprises a regulator, comprising: an output circuit configured to receive a feedback voltage and provide an output current based on the feedback voltage, wherein an output voltage of the regulator is based on, at least in part, the output current; a first MOSFET coupled to the output circuit and configured to receive the output voltage of the regulator; a second MOSFET coupled to the first MOSFET and configured to provide the feedback voltage based on, at least in part, the output voltage; a current sink coupled to the first MOSFET and the second MOSFET and configured to receive jointly a current from the first MOSFET and a current from the second MOSFET; a current source coupled to the second MOSFET and configured to provide the second MOSFET with the current in the second MOSFET, a connection of the current source and the second MOSFET is further coupled to the output circuit and configured to provide the feedback voltage based on, at least in part, the current in the second MOSFET; a load coupled to the regulator and configured to receive the output voltage and the output current.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating an electronic device according to an embodiment of the invention.

FIG. 2 is a block diagram illustrating a regulator according to an embodiment of the present invention.

FIG. 3 is a drawing illustrating the regulator in FIG. 2 according to an embodiment of the invention.

FIG. 4 is a drawing illustrating a regulator according to an embodiment of the invention.

FIG. 5 is a drawing illustrating a regulator according to an embodiment of the invention.

FIG. 6 is shows variation curves illustrating a power of a load and an output voltage provided by a regulator coupled to the load according to an embodiment of the invention.

### DETAILED DESCRIPTION OF THE ILLUSTRATED EMBODIMENTS

Various aspects and examples of the invention will now be described. The following description provides specific details for a thorough understanding and enabling description of these examples. Those skilled in the art will understand, however, that the invention may be practiced without many of these details. Additionally, some well-know structures or functions may not be shown or described in detail, so as to avoid unnecessarily obscuring the relevant description.

The terminology used in the description presented below is intended to be interpreted in its broadest reasonable manner, even though it is being used in conjunction with a detailed description of certain specific examples of the invention. Certain terms may even be emphasized below, however, any terminology intended to be interpreted in any restricted manner will be overtly and specifically defined as such in this Detailed Description section.

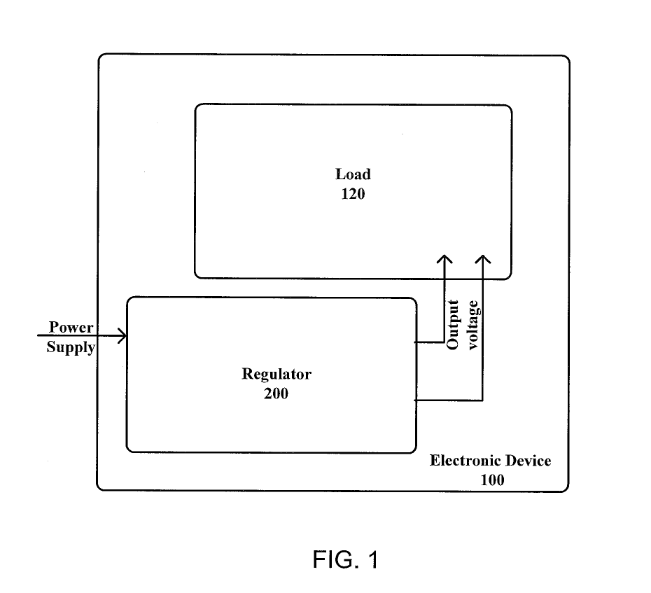

FIG. 1 is a block diagram illustrating an electronic device 100 according to an embodiment of the invention. The electronic device 100 includes a regulator 200 and a load 120 having an operation voltage of, e.g., about 1.8V. The power supply (e.g., V_{cc}) is about 3V. The regulator 200 provides an output voltage of about 1.8V based on the about 3V power supply to meet requirements of the load 120. The load 120 can be any component or any combination thereof which operates under this output voltage. Though the load 120 can operate under different voltages, it is usually expected to keep the output voltage stable.

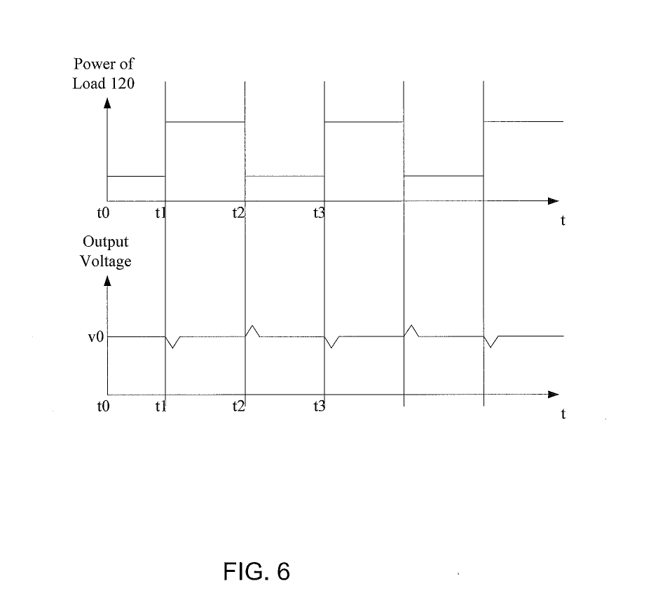

The power of the load 120 may sometimes change according to need. For example, a light-emitting diode needs more power to increase a luminance, a heating wire needs more power to heat an object to a higher temperature. More electricity from the regulator 200 is required when the power of the load 120 increases, the output voltage is hence “drawn down” momentarily. If the regulator 200 does not react in response to the power increment, the output voltage may keep decreasing and cannot drive the load 120 effectively. Similarly, less electricity from the regulator 200 is required when the power of the load 120 decreases, the output voltage is hence “pulled up” momentarily. In some embodiments, as will be described below, the regulator 200 is configured to offset the change of the output voltage caused by, for example but not limited to, the changing power of the load 120 so as to provide a static output voltage. An exemplary view of the relationship between the power of the load 120 and the output voltage provided by the regulator 200 is illustrated in FIG. 6, which will be described in detail later.

In some embodiments, the load 120 is required to operate most of the time, for example, a detection circuit in an on board unit (OBU) in an Electronic Toll Collection (ETC) system. The detection circuit is configured to detect if a wake up signal has been received and therefore has to operate most of the time. As the OBU is generally supported by a battery, it would be preferred if the regulator is power efficient.

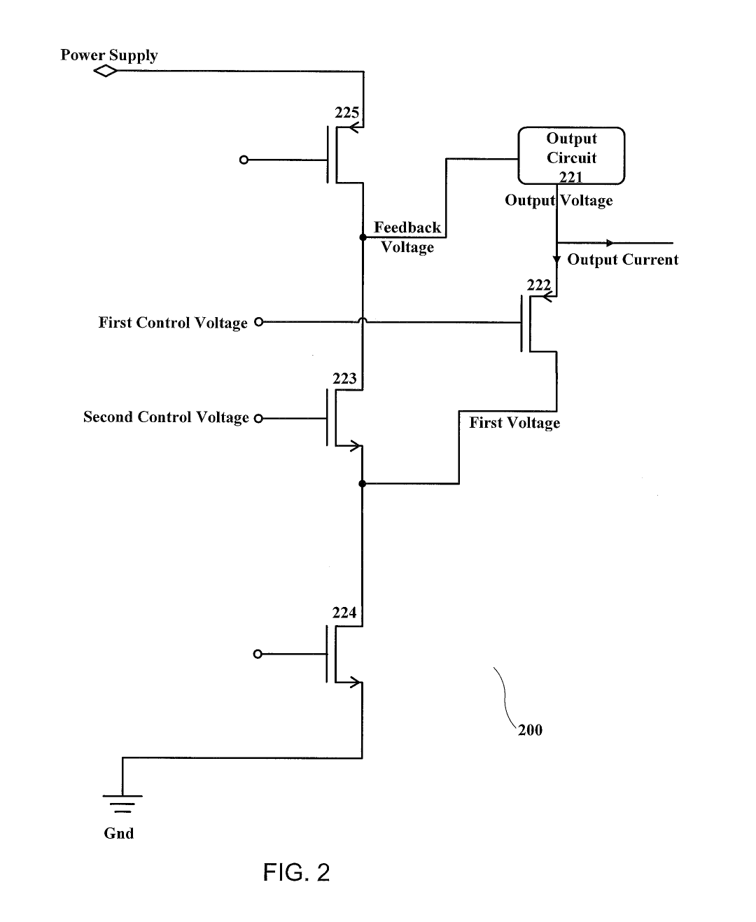

FIG. 2 is a drawing illustrating the regulator 200 in FIG. 1 according to an embodiment of the invention. As will be appreciated, in FIG. 2, one or more N-type MOSFET can be replaced by one or more P-type MOSFET and connections can be changed accordingly to form a variant, which is, however, within a scope of the present application. In this embodiment, MOSFETs 222 and 225 are P-type MOSFETs, MOSFETs 223 and 224 are N-type MOSFETs.

In the regulator 200, an output circuit 220 receives a feedback voltage and provides an output voltage for the regulator 200. Referring to FIGS. 1-2, a part of a current from the output circuit 220 flows to a first MOSFET 222 (referred to as MOSFET 222) and the rest flows outwards to the load 120 and is referred to as an output current of the regulator 200. As described above, the output current is adjusted by the feedback voltage to offset a change of the output voltage.

MOSFET 222 is, in this embodiment, a P-type MOSFET. A source (first input end) of MOSFET 222 is coupled to the output circuit 221 and configured to receive the output voltage. A gate (second input end) of MOSFET 222 receives a first control voltage. A drain (output end) of MOSFET 222 is configured to provide a first voltage based on the output voltage and the first control voltage. As can be seen from FIG. 2, the output voltage can be calculated according to equation (1):

vₒᵤₜ=v_{firstctl}+v_{GS222} (1)

where vₒᵤₜ is the output voltage of the regulator 200, v_{firstctl} is the first control voltage, which is generally consistent, v_{GS222} is the voltage between the source and gate of MOSFET 222. As MOSFET 222 is set to a saturation zone, v_{GS222} is subject to equation (2):

$${i}_{222} = {{I}_{DS} ( \frac{{v}_{GS 222}}{{V}_{th}} - 1 )}^{2} \qquad ( 2 )$$

where v_{GS222} is the voltage between the source and the gate of MOSFET 222 and may change with the output voltage, Vₜₕ is a threshold voltage of MOSFET 222, I_{DS} is the current in MOSFET 222 when v_{GS} is equal to 2×Vₜₕ. Note I_{DS}, Vₜₕ are both consistent.

A source (first input end) of MOSFET 223 receives the first voltage, a gate (second input end) of MOSFET 223 receives a second control voltage which is generally consistent. In an embodiment, the first and second control voltages are the same. A drain (output end) of the MOSFET 223 is configured to provide the control voltage which is received by the output circuit 221.

A current sink 224, which is realized by a MOSFET 224 is coupled to the first and second MOSFETs 222 and 223. Specifically, the source of MOSFET 224 is grounded, a gate is configured to receive a gate voltage which sets MOSFET 224 to receive an expected current from MOSFETs 222 and 223, and a drain of MOSFET 224 is configured to receive a current from MOSFETs 222 and 223. As a current sink, MOSFET 224 requires a fixed current, therefore, in case one of the currents from MOSFETs 222 and 223 changes, the other current is forced to change adversely.

A current source 225 is realized by a MOSFET 225. A source of MOSFET 225 is coupled to a power supply (providing a first voltage, e.g., about 3V), a gate of MOSFET 225 is configured to receive an appropriate gate voltage such that the current source 225 is providing an expected current to MOSFET 223. A drain of MOSFET 225 is coupled to the drain of MOSFET 223 and the output circuit 221.

In the regulator 200, a current from the output circuit 221 is divided at its drain to a first part which flows into the source of MOSFET 222 and a second part which flows towards the load 120 (not shown in FIG. 2) as an output current of the regulator 200. The current in MOSFET 222 (the first part of the current from the output circuit) flows to MOSFET 224 and finally to the ground. The current in MOSFET 225 flows to MOSFET 223, MOSFET 224 and then to the ground.

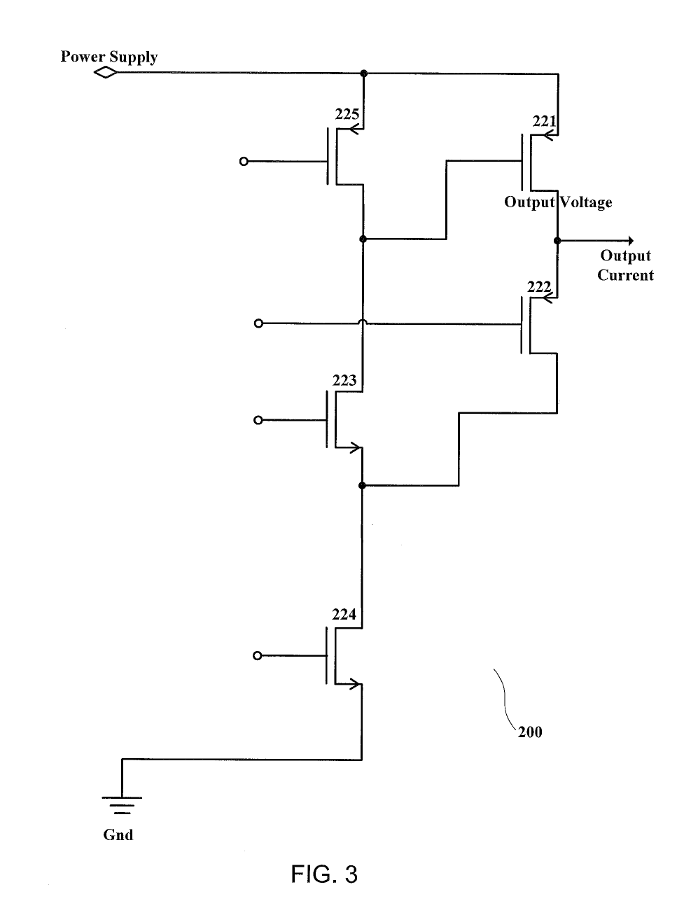

In some embodiments, the output circuit 221 is configured to increase the output current if the feedback voltage decreases in response to a decrement of the output voltage. FIG. 3 is a drawing illustrating the regulator 200 according to an embodiment of the invention. The output circuit 221 is realized by a MOSFET 221 having a source (first input end) coupled to the power supply, a gate configured to receive the feedback voltage. A current in MOSFET 221 (referred to as i₂₂₁) is generated based on the first voltage and the feedback voltage and according to equation (2).

In an embodiment, the power of the load 120 may change with time, e.g., as shown in FIG. 6. From t0 until t1 in FIG. 6, the power of load 120 keeps stable and the voltage is maintained at v0. At t1, for example, the load 120 suddenly requires a greater power and hence the output voltage is drawn down. Referring to FIGS. 1, 3 and 5 and particularly FIG. 3, the decreased output voltage is received by the source of MOSFET 222. According to equation (2), a current in MOSFET 222 decreases accordingly. As MOSFET 224 is configured to receive a fixed current, the decrement of i₂₂₂ has to be offset by i₂₂₃. Therefore, still according to equation (2), a voltage at the source of MOSFET 223 is forced to decrease so as to increase i₂₂₃. Though the current source 225 has a static source-gate voltage (v_{GS225}), a voltage at the drain of MOSFET 225 (i.e., the feedback voltage) decreases according to voltage current characteristic of a MOSFET to increase i₂₂₅ to comply with the increased i₂₂₃. Therefore, v_{GS221} is increased and the current in MOSFET 221 increases accordingly. The increment of i₂₂₅ is reflected at the output current provided to the load 120. As shown in FIG. 6, in response to the increased output current to the load 120, the output voltage starts to rise and then returns to v0. Compared to the duration from t0 to t1, the changing time of the output voltage may be relatively shorter such that the output voltage is substantially stable.

In an embodiment, at time t2, the power of the load 120 decreases suddenly (e.g., the power is changed automatically according to need or by a user), in response to the power decrement, the output voltage increases, as shown in FIG. 6. Referring to FIGS. 1, 3 and 5, particularly FIG. 2, when the output voltage increases, v_{GS222} increases, and hence i₂₂₂ increases according to equation (2). As the current sink 224 requires a fixed current, i₂₂₃ is forced to decrease to offset the increment of i₂₂₂. According to equation (2), the voltage at the source of MOSFET 223 is therefore increased to lower i₂₂₃. Though the current source 225 has a static source-gate voltage (v_{GS225}), a voltage at the drain of MOSFET 225 (i.e., the feedback voltage) increases according to voltage current characteristic of MOSFET 225 to decrease i₂₂₅ to comply with the decreased i₂₂₃. Therefore, v_{GS221} is increased and the current in MOSFET 221 increases accordingly. The decrement of i₂₂₅ is reflected at the output current provided to the load 120. As shown in FIG. 6, in response to the decreased output current to the load 120, the output voltage starts to fall and then returns to v0. Comparing to the duration from t2 to t3, the changing time of the output voltage may be relatively shorter such that the output voltage is substantially stable.

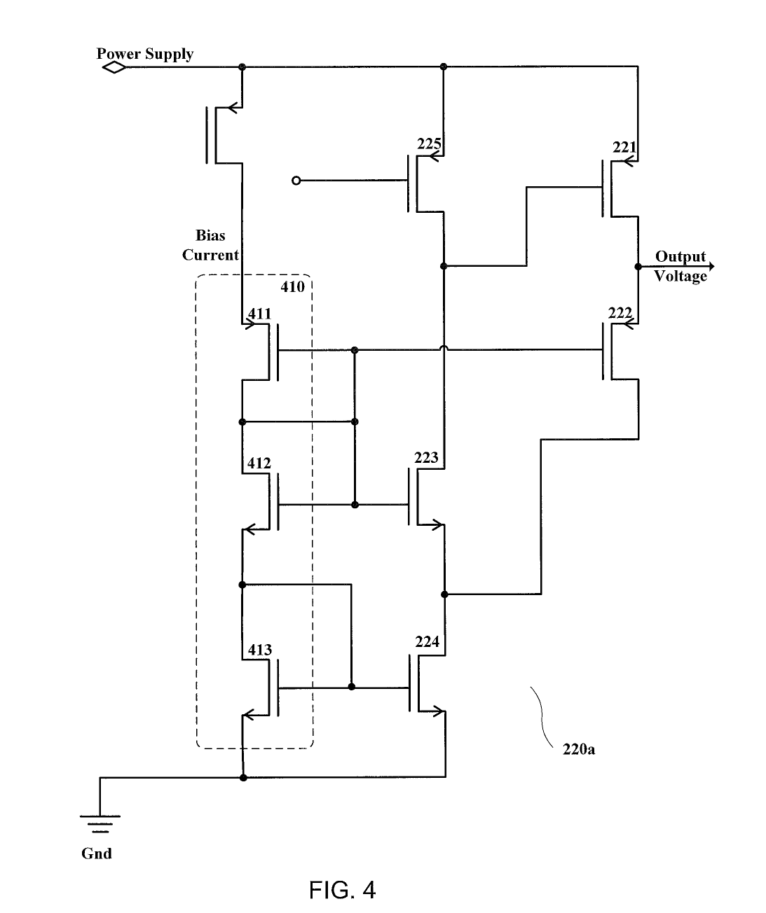

FIG. 4 is a drawing illustrating a regulator 220a according to an embodiment of the invention. In this embodiment, the regulator 220a include a reference voltage generation circuit 410 coupled to MOSFETs 222, 223 and 224. As shown in FIG. 4, the generation circuit 410 includes a MOSFET 411, a MOSFET 412 and a MOSFET 413. A source (first end) of MOSFET 411 is configured to receive a bias current which is generated based on the first voltage from the power supply. A gate (second end) and a drain (third end) of MOSFET 411 are coupled to each other. A source (first end) of MOSFET 413 is grounded, a gate of MOSFET 413 and a drain of MOSFET 413 are coupled to each other. A source of MOSFET 412 (first end) is coupled to the gate and drain of MOSFET 413, a gate of MOSFET 412 and a drain of MOSFET 412 are coupled to each other and to the gate and drain of MOSFET 411, and further to the gate of MOSFET 222 and the gate of MOSFET 223. In this embodiment, the first control voltage and the second control voltage as mentioned above are the same. A reference voltage is hence provided at the source of MOSFET 411, which may be calculated according to equation (3):

v_{ref}=v_{GS411}+v_{GS412}+v_{GS413} (3)

Examining FIG. 4, the output voltage can be calculated similarly according to equation (4):

vₒᵤₜ=v_{GS222}+v_{GS412}+v_{GS413} (4)

In some embodiments, v_{GS222} and v_{GS411} are configured to be the same so as vₑᵤₜ follows v_{ref}. In an embodiment, the bias current is equal to the current provided by the current source 225, in addition, the MOSFET 224 is configured to receive a double of the bias current. Therefore, i₂₂₂ is equal to i₄₁₁ and hence v_{GS222} is equal to v_{GS411}.

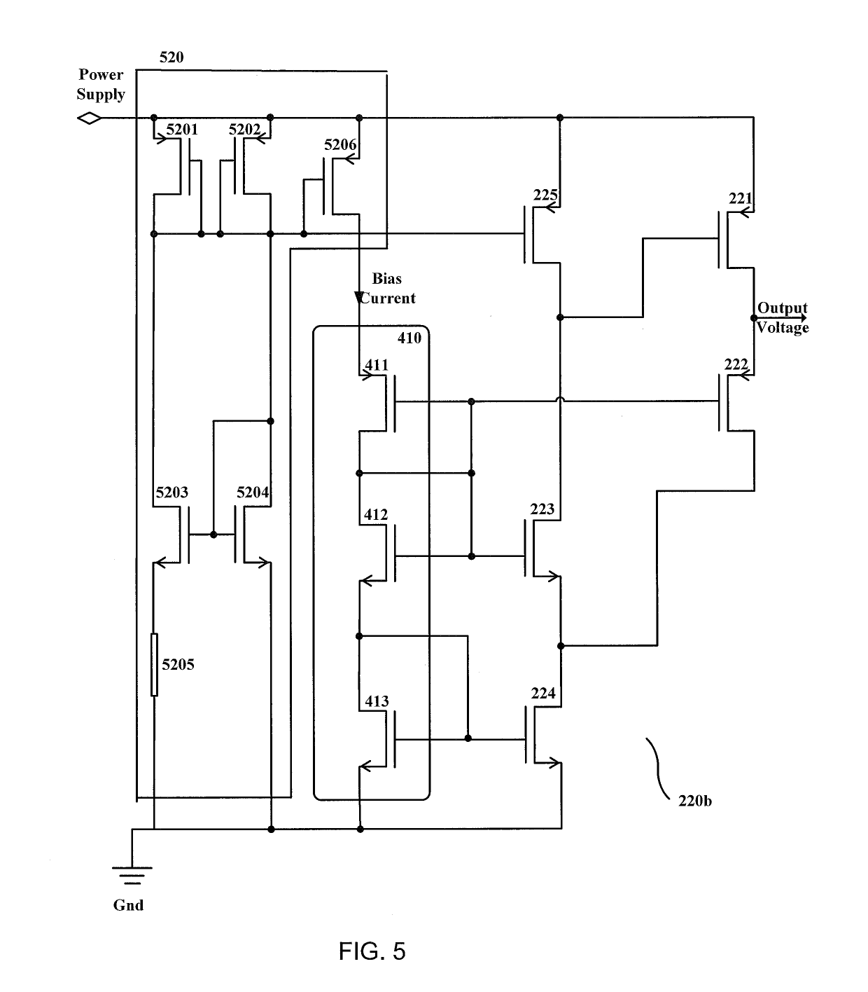

FIG. 5 is a drawing illustrating a regulator 220b according to an embodiment of the invention. In this embodiment, the regulator 220b includes a bias current generation circuit 520 coupled to the reference voltage generation circuit 410 to provide the bias current. The bias current generation circuit 520 includes MOSFETs 5201, 5202, 5203, 5204, 5206 and a resistor 5205. Wherein sources of MOSFET 5201 and 5202 are coupled to the power supply respectively. Gates of MOSFETs 5201, 5202, 5203, 5204 and 5206 are coupled together and further coupled to drains of MOSFETs 5201, 5202, 5203, 5204 and 225. A source of MOSFET 5203 is coupled to the resistor 5205 which is in turn grounded. A source of MOSFET 5204 is grounded. The bias current is provided at a drain of MOSFET 5206.

As will be appreciated, though a term “first input end” refers to a source of each MOSFET in the context, it is not intended to limit the scope of the invention thereby. In some embodiments, “first input end” may be a gate of a MOSFET or even a drain thereof. Moreover, though each MOSFET is illustrated specifically as a N-type MOSFET or a P-type MOSFET in the figures, variations which replace at least one N-type MOSFET by at least one P-type MOSFET or replace at least one N-type MOSFET and change connections accordingly are still within the scope of the present application.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A regulator, comprising:
an output circuit configured to receive a feedback voltage and provide an output current based on the feedback voltage, wherein an output voltage of the regulator is based on, at least in part, the output current;
a first MOSFET coupled to the output circuit and configured to receive the output voltage of the regulator;
a second MOSFET coupled to the first MOSFET and configured to provide the feedback voltage based on, at least in part, the output voltage;
a current sink coupled to the first MOSFET and the second MOSFET and configured to receive jointly a current from the first MOSFET and a current from the second MOSFET;
a current source coupled to the second MOSFET and configured to provide the second MOSFET with the current in the second MOSFET, a connection of the current source and the second MOSFET is further coupled to the output circuit and configured to provide the feedback voltage based on, at least in part, the current in the second MOSFET.

2. The regulator of claim 1, wherein a current in the output circuit is divided into a first part and a second part, wherein the first part flows into the first MOSFET and forms the current in the first MOSFET, the second part is configured as the output current of the regulator.

3. The regulator of claim 1, wherein the output circuit comprises a third MOSFET having a first input end configured to receive a first voltage, a second input end configured to receive the feedback voltage, and an output end coupled to the first MOSFET and configured to provide the output current based on, at least in part, the first voltage and the feedback voltage.

4. The regulator of claim 3, wherein the third MOSFET comprises a P-type MOSFET, the first input end of the third MOSFET comprises a source, the second input end of the third MOSFET comprises a gate, and the output end of the third MOSFET comprises a drain.

5. The regulator of claim 1, wherein the first MOSFET comprises a first input end configured to receive the output voltage, a second input end configured to receive a first control voltage, and an output end coupled to the second MOSFET and the current sink;
the second MOSFET comprises a first input end coupled to the output end of the first MOSFET and the current sink, a second input end configured to receive a second control voltage, and an output end coupled to the current source and the output circuit and configured to provide the feedback voltage based on, at least in part, the current in the second MOSFET.

6. The regulator of claim 5, wherein the first MOSFET comprises a P-type MOSFET, the first input end of the first MOSFET comprises a source, the second input end of the first MOSFET comprises a gate, and the output end of the first MOSFET comprises a drain;
wherein the second MOSFET comprises an N-type MOSFET, the first input end of the second MOSFET comprises a source, the second input end of the second MOSFET comprises a gate, and the output end of the second MOSFET comprises a drain.

7. The regulator of claim 1, wherein the regulator is configured to change the output current in response to a change of the output voltage.

8. The regulator of claim 5, further comprising a reference voltage generation circuit coupled to the first and second MOSFETs and configured to provide the first control voltage to the first MOSFET and provide the second control voltage to the second MOSFET.

9. The regulator of claim 8, wherein the reference voltage generation circuit comprises:
a fourth MOSFET having a first end configured to receive a bias current, a second end and a third end coupled to each other;
a fifth MOSFET having a second end and a third end coupled to each other and a first end which is grounded;
a six MOSFET having a second end and a third end coupled to each other and further coupled to the second and third ends of the fourth MOSFET, and a first end coupled to the second and third ends of the fifth MOSFET;

10. The regulator of claim 9, wherein the first control voltage is equal to the second control voltage.

11. The regulator of claim 9, wherein the bias current is equal to the current provided by the current source to the second MOSFET, the current sink is configured to receive a current which is a double of the bias current.

12. An electronic device, comprising:
a regulator, comprising:
an output circuit configured to receive a feedback voltage and provide an output current based on the feedback voltage, wherein an output voltage of the regulator is based on, at least in part, the output current;
a first MOSFET coupled to the output circuit and configured to receive the output voltage of the regulator;
a second MOSFET coupled to the first MOSFET and configured to provide the feedback voltage based on, at least in part, the output voltage;
a current sink coupled to the first MOSFET and the second MOSFET and configured to receive jointly a current from the first MOSFET and a current from the second MOSFET;
a current source coupled to the second MOSFET and configured to provide the second MOSFET with the current in the second MOSFET, a connection of the current source and the second MOSFET is further coupled to the output circuit and configured to provide the feedback voltage based on, at least in part, the current in the second MOSFET;
a load coupled to the regulator and configured to receive the output voltage and the output current.

13. The electronic device of claim 12, wherein a current in the output circuit is divided into a first part and a second part, wherein the first part flows into the first MOSFET and forms the current in the first MOSFET, the second part is configured as the output current of the regulator.

14. The electronic device of claim 12, wherein the output circuit comprises a third MOSFET having a first input end configured to receive a first voltage, a second input end configured to receive the feedback voltage, and an output end coupled to the first MOSFET and configured to provide the output current based on, at least in part, the first voltage and the feedback voltage.

15. The electronic device of claim 14, wherein the third MOSFET comprises a P-type MOSFET, the first input end of the third MOSFET comprises a source, the second input end of the third MOSFET comprises a gate, and the output end of the third MOSFET comprises a drain.

16. The electronic device of claim 12, wherein the first MOSFET comprises a first input end configured to receive the output voltage, a second input end configured to receive a first control voltage, and an output end coupled to the second MOSFET and the current sink;
the second MOSFET comprises a first input end coupled to the output end of the first MOSFET and the current sink, a second input end configured to receive a second control voltage, and an output end coupled to the current source and the output circuit and configured to provide the feedback voltage based on, at least in part, the current in the second MOSFET.

17. The electronic device of claim 16, wherein the first MOSFET comprises a P-type MOSFET, the first input end of the first MOSFET comprises a source, the second input end of the first MOSFET comprises a gate, and the output end of the first MOSFET comprises a drain;
wherein the second MOSFET comprises an N-type MOSFET, the first input end of the second MOSFET comprises a source, the second input end of the second MOSFET comprises a gate, and the output end of the second MOSFET comprises a drain.

18. The electronic device of claim 12, wherein the regulator is configured to change the output current in response to a change of the output voltage.

19. The electronic device of claim 16, further comprising a reference voltage generation circuit coupled to the first and second MOSFETs and configured to provide the first control voltage to the first MOSFET and provide the second control voltage to the second MOSFET.

20. The electronic device of claim 19, wherein the reference voltage generation circuit comprises:
a fourth MOSFET having a first end configured to receive a bias current, a second end and a third end coupled to each other;
a fifth MOSFET having a second end and a third end coupled to each other and a first end which is grounded;
a six MOSFET having a second end and a third end coupled to each other and further coupled to the second and third ends of the fourth MOSFET, and a first end coupled to the second and third ends of the fifth MOSFET;

21. The electronic device of claim 20, wherein the first control voltage is equal to the second control voltage.

22. The electronic device of claim 20, wherein the bias current is equal to the current provided by the current source to the second MOSFET, the current sink is configured to receive a current which is a double of the bias current.

23. The electronic device of claim 12, wherein the electronic device comprises a transceiver in an electronic toll collection system.
